(19) United States
(12) Patent Application Publication
(10) Pub. No.: US 2002/0018537 A1
(43) Pub. Date: Feb. 14, 2002

(54) Configuration and method for calibrating an interface for multichannel synchronized data transmission

(76) Inventor: Jurgen Zielbauer, Munchen (DE)

Correspondence Address: LERNER AND GREENBERG, P.A., Post Office Box 2480, Hollywood, FL, 33022-2480, US

(21) Appl. No.: 09/920,101

(22) Filed: Aug. 1, 2001

(30) Foreign Application Priority Data
Aug. 1, 2000 (DE) 100 37 477.8

(51) Int. Cl. H04L 23/00

(52) U.S. Cl. 375/377

(57) ABSTRACT

The invention relates to an interface with parallel transfer channels for transmission of a number of parallel data signals and, possibly, command signals between associated outer connections and associated circuit points in an electronic assembly. A synchronization signal connection carries a synchronization signal indicating the time base for the parallel-transmitted signals. Selected examples of the transfer channels each contain an individually controllable delay device for setting a time delay for a signal transmission in the relevant transfer channel. Furthermore, a control device is provided in order to sense, in each selected transfer channel, the actual value of the relative phase of the data signal with respect to the associated, accompanying synchronization signal, and to control each of the delay devices as a function of the respectively sensed actual value, in the sense of matching the actual value to a predetermined, common nominal value.

### BACKGROUND OF THE INVENTION

### FIELD OF THE INVENTION

The invention lies in the signal processing and data transmission fields. More specifically, the invention relates to a configuration for calibration of an interface for synchronized data transmission. The interface contains parallel transfer channels for transmission of a number of parallel data signals and, possibly, command signals between associated outer connections and associated circuit points in an electronic assembly, and at least one synchronization signal connection for a synchronization signal which indicates the time base for the parallel-transmitted signals. The invention also relates to a calibration method using such a configuration. The preferred, but not exclusive, field of application of the invention is in an interfaces for data communication between high-speed digital information memories, and associated controllers.

When receiving binary-coded digital data, the sequence of the incoming data bits is normally sampled in the receiving assembly using a frequency which corresponds to the bit rate.

The sampling signal used for this purpose has to be matched to the clock rate of the received bits not only in terms of its frequency but also in terms of its phase, such that the sampling times occur as centrally as possible in the bit periods and are not too close to the bit limits, where reliable detection of the respective binary value is no longer guaranteed. In terms of the absolute timescale, this phase synchronization must be more precise, the higher the bit rate is.

The receiving-end sampling using the clock rate of the incoming data bits can be synchronized by deriving the sampling signal produced at the receiving end from the same clock source which governs the clock rate of the transmitted bit sequence at the transmission end. However, in the process, it is necessary to take account of any differences in the delay times which the clock signals are subject to on their way from the common source to the transmission end, on the one hand, and then to the receiving end, on the other hand. Furthermore, it is necessary to take into account the delay time of the data from the transmission end to the receiving end. Suitable measures for accurate synchronization of the sampling signal produced at the receiving end can be taken only when these delay time parameters are known or can be reproduced sufficiently well. However, this is generally scarcely feasible, or feasible only with difficulty, for bit rates above 100 MHz. At higher bit rates in the order of magnitude of 200 MHz (or more), other methods are thus preferably used for sample synchronization, wherein a time base for the sampling signal, which is intended to be used for sampling the data bits at the receiving end, is transmitted as a synchronization signal in parallel with the data, from the transmission end to the receiving end, within the same cable harness.

One of these methods produces the synchronization signal to be transmitted in time with the data bits to be transmitted. To this end, a bit sequence wherein the two binary values alternate corresponding to the bit rate of the data to be transmitted, and using the same clock flanks and in the same manner as the data bit sequence to be transmitted, is simulated at the transmission end. The flanks of the “strobe signal” that is formed in this way are coincident in time, assuming the function is correct, with the bit limits in the data bit sequence. They also arrive at the same time together with them at the receiving end; they can thus be used directly for data sampling at the receiving end, preferably after passing through a delay equal to half the bit period. This method is suitable for unidirectional data connections, but can also be used for bidirectional connections by providing each of the two ends with their own clock source and a respective dedicated circuit for producing the strobe signal to be sent to the other end.

A different method, which is suitable only for bidirectional connections, is for a clock signal which is produced continuously at a first end where it is used for sampling the transmitted data to be sent as a synchronization signal via a first clock line to the opposite end, where it can also be used for reception sampling and for transmission sampling. This clock signal, which arrives at the opposite end, is also reflected there and is transmitted back via a second clock line to the first end, where it is used for reception sampling there.

The methods mentioned above have been proven for data communication at twice the bit rate at which the data bits follow one another at twice the frequency of the clock signal, that is to say they are sampled both with the rising flank and with the falling flank of the clock signal. They are used for interchanging data between a memory controller and high-speed dynamic RAM memories, for example in order to provide different memory systems, which are known by the acronyms DDRAM (Double Data Rate Dynamic RAM), RDRAM (Rambus Dynamic RAM) and SLDRAM (SynchLink Dynamic RAM).

Since technical development is aiming to achieve ever higher clock frequencies (currently up to 400 MHz), the requirements for the accuracy of the hardware components are becoming increasingly more stringent. The tolerance limits, which are thus tighter, lead to increased scrap due to the unavoidable production variations. Despite the simultaneous transmission of an accompanying synchronization signal during operation, such production variations can, specifically, lead to the correct timing being lost between the data bits and the signal which is used for sampling.

In order to prevent this problem, various measures are known for retrospective calibration of a data connection that has been produced between a memory and the memory controller in the interface at the memory end. One of these measures for SLDRAMs is to use repeated writing and reading by the memory controller to check whether the timing of the memory module is correct. If necessary, the controller loads SLDRAM-internal registers, by means of which the timing can be varied coarsely (see “Draft Standard for a High-Speed Memory Interface (SnchLink)”, Draft 0.99 IEEE p1596.7-199X). This calibration can be carried out only in relatively long time steps, cannot be carried out for unidirectional command signals (for example row and column selection signals), and can be carried out only globally and in a standard manner for the entire group of all the data signals.

In conjunction with RDRAMs, it is known for calibration to be carried out at the time of the wafer test, by the overall timing for groups of associated signals being defined once by a circuit change by means of fuse technology (for example by disconnecting conductive connections on the chip by vaporization). However, the wafer test cannot be carried out at the frequencies required during subsequent use (approximately 200-400 MHz) and, furthermore, the influence of the housing, which is to be provided later, on the signal delay times cannot be observed in this case. This calibration is thus not exactly matched to subsequent user operation.

### SUMMARY OF THE INVENTION

It is accordingly an object of the invention to provide a method and a configuration for calibrating an interface for multi-channel synchronous data transmission, which overcomes the above-mentioned disadvantages of the heretofore-known devices and methods of this general type and which allow high-precision time signal calibration for synchronized data communication between electronic assemblies, taking into account the actual operational conditions.

With the foregoing and other objects in view there is provided, in accordance with the invention, a configuration for calibrating an interface with a plurality of parallel transfer channels for transmission of a number of parallel data signals and, optionally, command signals between associated outer connections and associated circuit nodes in an electronic assembly, and with at least one synchronization signal connection for a synchronization signal determining a time base for the parallel-transmitted signals, comprising:

individually controllable delay devices respectively contained in selected transfer channels for setting a time delay for the signal transmission in the respective transfer channel as a function of a delay control signal;

a control device connected in the interface and including a sensing means for sensing, in each selected transfer channel, an actual value of a relative phase of the respective data signal with respect to an associated, accompanying synchronization signal, and means for producing the delay control signal in dependence on a respectively sensed actual value for controlling each of the delay devices in order to match the actual value to a predetermined, common setpoint value.

In other words, the configuration according to the invention is designed for calibration of an interface which contains parallel transfer channels for transmission of a number of parallel data signals, and possibly command signals, between associated outer connections and associated circuit points in an electronic assembly, and has at least one synchronization signal connection for a synchronization signal which indicates the time base for the parallel-transmitted signals. According to the invention, selected examples of the transfer channels each contain an individually controllable delay device for setting a time delay for the signal transmission in the relevant transfer channel as a function of a delay control signal, and a control device is provided which contains means in order to sense, in each selected transfer channel, the actual value of the relative phase of the data signal with respect to the associated, accompanying synchronization signal, and means for production of the delay control signal as a function of the respectively sensed actual value, in order to control each of the delay devices in the sense of matching the actual value to a predetermined, common nominal value.

A calibration method according to the invention which makes use o the above-outlined configuration is characterized in that the control device is temporarily switched on before the start of user operation of the interface or in pauses during user operation, and in that the source which supplies the signals to be transmitted via the selected transfer channels is caused, when the control device is in the switched-on state, to produce these signals in each case as a pattern signal with signal transitions which are switched on uniquely to be associated with the time base.

An alternative embodiment of the method is wherein the control device is for examples of the selected transfer channels during user operation of the interface, in each case during intervals wherein the signals to be transmitted via the relevant transfer channels have transitions, which can be uniquely associated with the time base.

The invention allows each of the parallel data channels which are provided between two assemblies in a multichannel synchronized data connection to be calibrated individually. It is thus also possible to compensate for any phase differences between the data channels. Such differences can arise due to unavoidable, production-dependent differences between the parallel switching elements which are used for sampling the parallel data bits at the transmission end, and from delay time differences between the parallel transmission lines from the transmission end to the receiving end. In the past, the tolerance limits for these differences had to be designed to be so narrow that a critical level was not exceeded even when such differences accumulated. This means that it was necessary to ensure that the difference between the phases of the “earliest” and of the “latest” data bit stream at the receiving end, added to the possible fluctuation width of the synchronization signal phase, could not become greater than the amount of time which was available for unique sampling of the data bit within one bit period. For transfer speeds corresponding to a frequency of, for example, 400 MHz, this means that the phase differences between the data channels could amount to only a few tens of pico-seconds (ps) in the past.

For a predetermined transfer speed, the use of the invention allows the tolerances relating to the time accuracy to be widened during production, since the effects of production variations can be compensated for, according to the invention. Production variations thus lead to far less scrap than in the past. Alternatively, the data transfer speed can be increased since, when producing higher-speed components, only reduced “reserves” need be planned into the accuracy of the hardware. The specifications for other components in the vicinity of the assembly (boards, plug connectors and the like) can also be made less stringent, since associated production variations are likewise compensated for during the calibration process. Finally, temperature-dependent or aging-dependent changes to signal delay times can be compensated for by repeated calibration.

Other features which are considered as characteristic for the invention are set forth in the appended claims.

Although the invention is illustrated and described herein as embodied in an arrangement and method for calibration of an interface for multichannel synchronized data transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic block diagram of a first embodiment of a configuration according to the invention for the calibration of reception operation;

FIG. 2 is a schematic block diagram of a second embodiment of a configuration according to the invention for the calibration of reception operation; and

FIG. 3 is a schematic block diagram of the configuration of FIG. 1, with additional means for the calibration of transmission operation.

### DESCRIPTION OF THE PREFERRED EMBODIMENTS

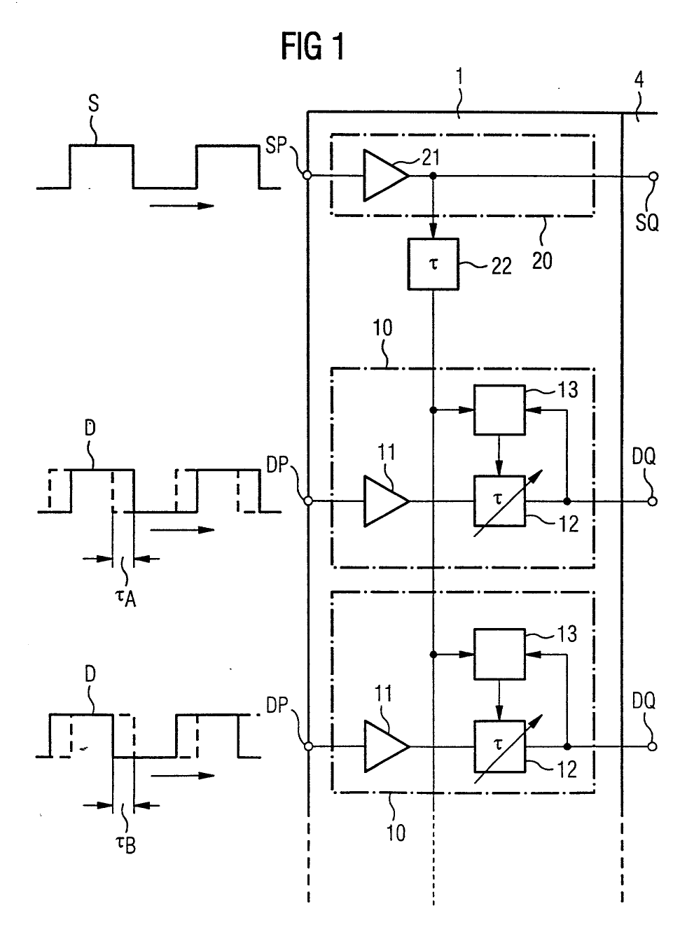

Referring now to the figures of the drawing in detail and first, particularly, to FIG. 1 thereof, there is seen an interface 1 with a number of parallel data transfer channels (D channels) 10 for transmission of parallel data signals D, which are received at associated outer data connections (D pins) DP at associated circuit points DQ in an electronic assembly 4. The drawing shows only two D channels 10 in detail, which represent what is, in reality, generally a very much larger number of channels. All of the channels are identically designed. The interface 1 illustrated furthermore contains a synchronization signal transfer channel (S channel) 20 for transmission of a reception synchronization signal S, which accompanies the data signals and is received at an outer synchronization signal connection (S pin) SP, at an associated circuit point SQ in the assembly 4. Each of the D channels 10 in the interface 1 contains a reception circuit 11, which is connected to the relevant D pin DP, and the S channel 20 contains a reception circuit 21 which is connected to the S pin SP. In the illustrated situation, the reception circuits 11, 21 are unclocked signal amplifiers, for example differential amplifiers.

The assembly 4, whose internal construction is not illustrated, may be any circuit which uses the received data signals for example a memory module such as a DRAM. During operation, the D pins DP and the S pin SP are connected via a harness of associated transmission lines or a bus to another assembly, which represents the “opposite end”, for example to a memory controller.

On the left, FIG. 1 shows the waveforms of received signals in the situation where, the opposite end is transmitting as the synchronization signal S the clock signal by means of which the data bits were sampled there at twice the clock rate. This means that, in the ideal state, each flank of the synchronization signal S appears at the same time as the center of an associated bit in each data signal D. The waveforms of the data signals D, which are shown by solid lines, illustrate this ideal state. However, in practice, it must be assumed that different data signals D differ from one another in terms of their phase, due to unavoidable differences in the time response of the transmission-end sampling and in the transmission lines. The dashed lines for the D waveforms in FIG. 1 illustrate the situation where one data signal is lagging behind the ideal phase by an amount of time τ_{A}, while the other data signal is leading the ideal phase by an amount of time τ_{B}. Once a critical level is exceeded, such phase differences can lead to sampling errors, if the received data are sampled by means of the received, common synchronization signal S in the assembly 4.

In order to compensate for these phase differences, each D channel 10 in the interface 1 contains a device to produce a variable delay for the data signals transmitted by the relevant channel. In the arrangement shown in FIG. 1, the delay device is a controllable delay element 12, which is arranged in series with the associated reception circuit 11 in the data signal path between the relevant D pin DP and the associated circuit point DQ in the assembly 4. Furthermore, each D channel 10 contains a phase detector 13, whose reference input receives the received synchronization signal S from the output of the reception circuit 21 of the S channel 20, via a phase shifter 22. The other input of the phase detector 13 receives the delayed data signal from the output side of the series circuit which contains the reception circuit 11 and the controllable delay element 12.

The phase shifter 22 is a delay element which is set (or can be set) to a time delay which is equal to the difference between the phase of the flanks of the synchronization signal S and the nominal phase of the flanks of the data signals D. In the case of the signals illustrated in FIG. 1 (for sampling at twice the clock rate and using synchronization signal flanks in the center of the data bits), this “systematic” phase difference is preset to one quarter of a clock period, or 90°. The phase detector 13 in each D channel 10 is designed such that it measures the time difference between the flanks of its two input signals, and produces a corresponding control signal at its output. Each controllable delay element 12 is preferably designed such that its delay time can be selectively shortened or lengthened with respect to a mean value which is equal to one entire bit period (or half a clock period), depending on the magnitude and direction of the sense signal produced by the phase detector 13, to be precise in the sense of reducing the measured time difference to zero. It should be possible to adjust the delay elements 12 with high time resolution, for example in the order of magnitude of 10 ps for a clock rate of 400 MHz. The control range of the controllable delay elements 12 must be designed to be at least equal to the maximum time shift which can be expected between different data signals D. The phase differences τ_{A} and τ_{B} are then compensated for in the desired manner.

The controllable delay elements 12 and the control device formed by the phase detectors 13 and the phase shifter 22 thus, as shown in FIG. 1, form an arrangement by means of which the interface 1 can be calibrated with high accuracy for received signals. During operation, the phase difference at the inputs of each phase detector 13 is automatically regulated to zero by virtue of the feedback passing via the associated delay element 12. In consequence, each data signal transmitted through the interface 1 has exactly the same phase angle at the circuit point DQ in the assembly 4 as the transmitted synchronization signal at the circuit point SQ, governed by the phase angle (delay time) of the phase shifter 22.

A precondition for the calibration process is the appearance of a deterministic signal sequence in each of the received data signals D. This means that the waveform of the data signal must contain sufficient features to allow phase discrimination. If desired, a signal sequence which is suitable for this purpose can be produced just for calibration purposes at the opposite end, for example in the form of a binary sequence, which alternates with the bit rate, for each data signal, as is shown as an example in FIG. 1, that is to say “0” and “1” alternately (binary sequence 0-1-0-1- . . . ). However, it may also be worthwhile using other bit patterns instead of this binary sequence, in order to include the definitively existing influence of the signal sequence, such as 0-0-1-1-0-0-1-1- . . . or 0-0-0-0-0-0-0-0-1-0-0- . . . A periodic patterns may also be worthwhile, for example a pseudo-random sequence. The control of the controllable delay elements 12 can preferably be switched on and off, for example by separate means (not illustrated) for activation and deactivation of the control inputs on these elements, and for locking the currently selected amount of delay when deactivation has taken place.

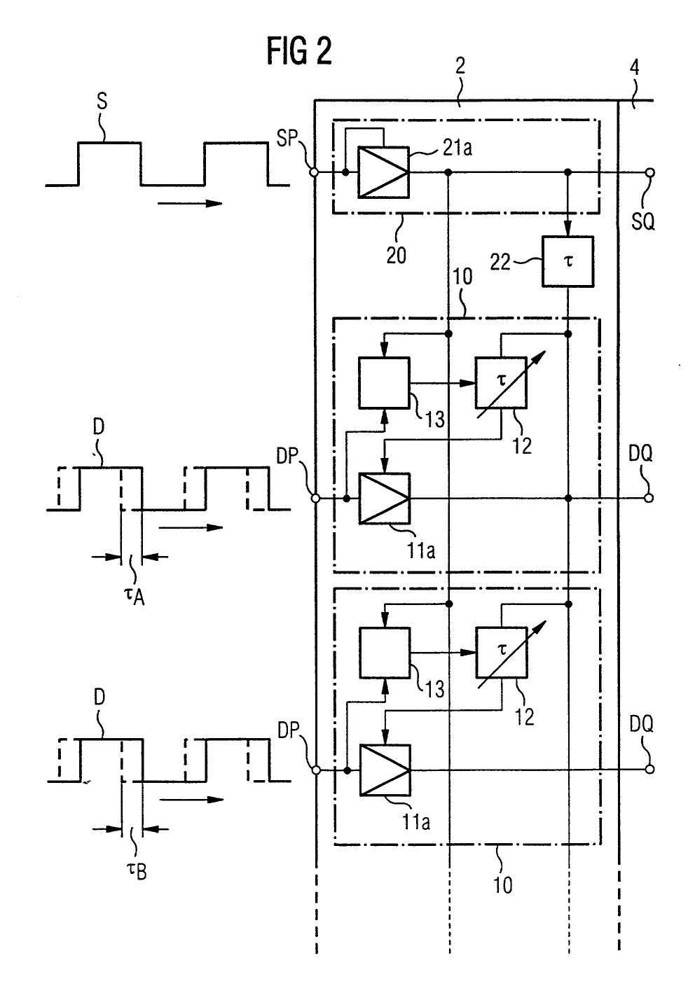

FIG. 2 shows a modification of the configuration illustrated in FIG. 1. In the interface 2 as shown in FIG. 2, the reception circuits 11a for the D channels 10 are in the form of latching circuits. These circuits use the time base of the received synchronization signal S in order to sample the data signals D, which are received at the D pins DP, in the center of the respective data bits, and to maintain the relevant sample value at its output until the next sampling process, as is known per se and is normal, for example, for interfaces for DDR-RAMS. FIG. 2 furthermore shows the situation wherein the synchronization signal S is a strobe signal, whose flanks are produced at the transmission end in synchronism with the bit flanks of the data signals D (and not, as shown in FIG. 1, in synchronism with the centers of the data bits).

When using latching reception circuits in the D channels of the interface, the controllable delay elements 12 may either, as is the situation in FIG. 1, be arranged in the data signal path in series with the relevant reception circuit 11a or, as shown in FIG. 2, may be located in the latching signal line, via which the synchronizing latching signal is applied to the reception circuit 11a in order to sample the data bits. According to FIG. 2, the latching signal is derived from the received synchronization signal S (strobe signal) via the phase shifter 22, which is connected to the output of the reception circuit 21a of the S channel 20. This reception circuit 21a is likewise a latching circuit, for delay time matching purposes, preferably of the same type as the latching circuits 11a, only with the difference that its control input is connected directly to its signal input, in order to pass the strobe signal S through directly in the same clock cycle.

The phase shifter 22, as shown in FIG. 2, produces a 90° phase delay (time delay equal to one quarter of the period of the signal S) as in the case of FIG. 1, so that the flanks of the latching signal are as coincident as possible with the centers of the data bits to be sampled. In the case of FIG. 2, the phase detector 13 is connected such that its reference input receives the received data signal D from the relevant D pin DP, while its signal input receives the received synchronization signal S from the output of the reception circuit 21a of the S channel 21.

When the nominal state is present on a D channel 10 in the interface 2 shown in FIG. 2, that is to say when the data signal D received on this channel is in-phase with the strobe signal S received on the S channel 20, the phase difference sensed at the phase detector 13 is equal to zero, as a result of which the delay element 12 is set to the center of its control range, which preferably corresponds to a delay time equal to one bit period (half the period of the signal S). If the phase of the data signal D lags the nominal phase by τ_{A} or leads it by τ_{B} (as shown by the dashed line in the waveform D), then the output signal from the phase detector 13, which is not zero, shortens or lengthens the delay time of the controllable delay element 12 in the sense of compensating for the lag or lead, as is the situation in FIG. 1. The result of this calibration is that, even when there are phase differences between the various received data signals D, all these signals are synchronous and are each reliably latched to the center of their bits, and are thus transmitted to the assembly precisely in-phase.

In the situation where the assembly 4 is also designed for transmitting data signals, the interface can be provided with additional data transfer channels, which are arranged back-to-back in parallel with the receiving D channels 10, in order to transmit the parallel bit streams of the transmission data, produced in the assembly, to the D pins DP. These transmitting D channels do not necessarily need to be equipped with means for calibration. If the opposite end also has an interface which, in a similar way to the interface in the assembly 4, contains an arrangement for calibration of the reception operation there, phase differences are compensated for in both communication devices. If, however, the opposite end communicates via a bus having more than one assembly, problems can occur since the opposite end cannot provide calibration for a number of assemblies, with their individual delay time errors. This is the situation, for example, when the opposite end is intended to communicate, as a bus controller, with a number of memory modules.

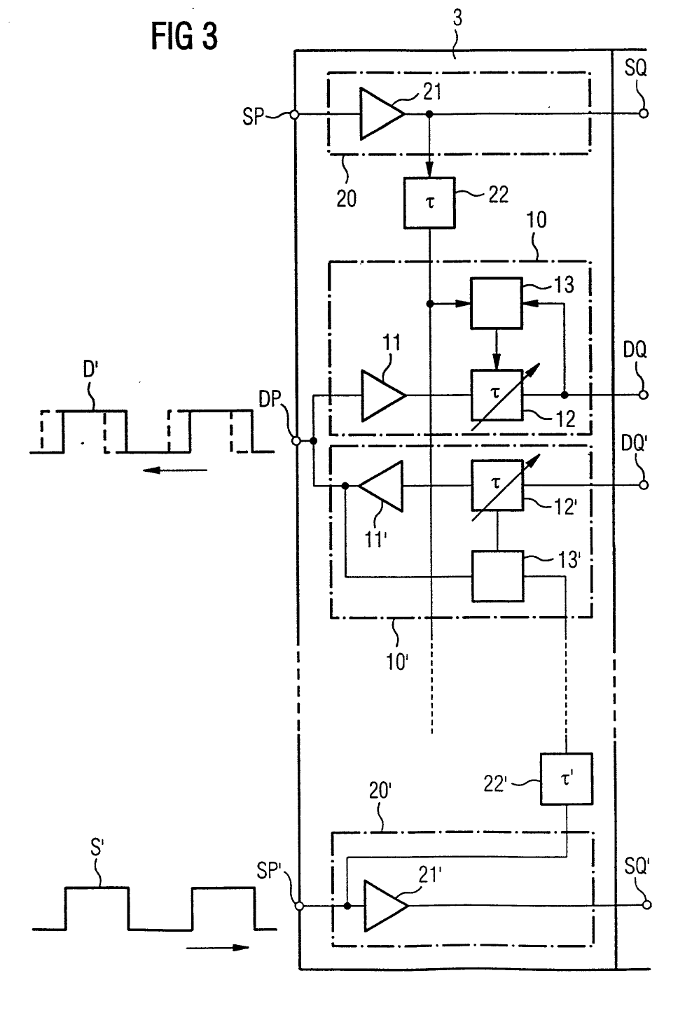

This problem is avoided if both the receiving and the transmitting data transfer channels can be calibrated in each of the assemblies. FIG. 3 shows an interface 3 having an arrangement for this purpose.

The interface 3 is equivalent to the interface 1 shown in FIG. 1 to the extent that it contains a number of receiving D channels 10 for transmission of received data signals from a respectively associated D pin DP to the assembly 4, and has the S channel 20 for the accompanying synchronization signal S received at the S pin SP (this signal is not shown in FIG. 3). Only one of the D channels 10, which are all identical to one another, is shown in FIG. 3, for the sake of simplicity. The S channel 20 and each D channel 10 are constructed in precisely the same way, and are connected to the same means for calibration as in the situation in FIG. 1. This means that the elements 11, 12, 13, 21, 22 shown in FIG. 3 operate in the same way as described above with reference to FIG. 1, in order to compensate for phase differences between the received data signals.

In addition to each receiving D channel 10, the interface 3 contains a transmitting D channel 20′, which is arranged back-to-back in parallel therewith, for transmitting an associated transmission data signal D′ from the assembly to the associated D pin DP. In addition, in the case of FIG. 3, a second S channel 20′ is provided, for transmission of a synchronization signal S′ associated with the data to be transmitted. In the illustrated case, the signal S′ is a clock signal, whose flanks are intended to appear at the same time as the centers of the bits of the data signals D′ which are transmitted to the D pins DP. The transmission data D′ have been synchronized in the assembly 4 with the aid of the synchronization signal S′, which was generated by an external component, is received at the connection SP′, and is passed via a reception circuit 21′ to the assembly 4, as is normal, for example, for data communication in an RDRAM memory system. The transmission synchronization signal S′ may, however, also be a signal produced in the assembly 4 itself; in this case, it is transmitted to the opposite end, so that a transmission circuit with the opposite transmission direction must be used instead of the reception circuit 21′. In the case of a single-wire synchronization signal connection between the assembly 4 and the opposite end, as is normal, for example, for DDRAM memory systems using strobe signal transmission, only one S pin SP and one bidirectional S channel is provided. In this case, the signal for the reference inputs of the phase detector 13′ would need to be derived from this S pin via the phase shifter 22′.

Each transmitting D channel 10′ contains a transmission circuit 11′, for example a differential amplifier as a driver, in series with a controllable delay element 12′ whose control input is connected to the output of a phase detector 13′. At its reference input, the phase detector 13′ receives the synchronization signal S′ via a phase shifter 22′, and, at its signal input, it receives the transmitted data signal D′ from the D pin of the relevant D channel. The transmission circuit 11′, the controllable delay element 12′ and the phase detector 13′ preferably have the same characteristics as the elements 11, 12, and 13 in the receiving D channel 10.

As stated, the transmitted data signals D′ are all intended to be at a phase angle with respect to the synchronization signal S′ such that the centers of the data bits occur at the same time as the flanks of the signal S′. This ideal state, which is to be aimed for, is represented by the waveform of the data signal D′ shown by a solid line. A delay which is equal to one quarter of the period of the signal S′ is permanently set on the phase shifter 22′. Thus, when the data signal D′ has the desired phase angle, the phase difference between the input signals to the phase detector 13′ is equal to zero. In this case, the output signal of the phase detector 13′ sets the delay element 12′ to the center of its control range, which corresponds to a delay time equal to one bit period (half the period of the synchronization signal S′). If the phase of the transmitted data signal D′ lags the nominal phase (as shown by the dashed line for the waveform D′), or leads it, then the output signal from the phase detector 13′, which is not zero, shortens or lengthens the delay time of the controllable delay element, in the sense of compensating for the lag or lead.

Phase differences between the bits of the parallel-transmitted data signals D′ are thus compensated for accurately. A precondition for this calibration operation is also that a deterministic signal sequence appears in each of the transmitted data signals D′. Such a sequence can be produced, if desired, just for calibration purposes in this case as well, to be precise in the assembly 4 and, for example, in the form of a binary sequence, which alternates with the bit rate, for each data signal D′, as is shown in FIG. 3. The control of the controllable delay elements 12′ can likewise preferably be switched on and off, for example by separate means (not illustrated) for activation and deactivation of the control inputs on these elements, and for locking the currently set amount of the delay when deactivation has taken place.

All the configurations described with reference to FIGS. 1 to 3 are just exemplary embodiments and can be modified in a wide range of manners without having to depart from the principle of the invention. In the arrangements shown in FIGS. 1 and 2, the phase shifters 22 and 22′, respectively, can be omitted, if the synchronization signal S or S′, respectively, is produced with its flanks synchronized to the associated data (for example as a strobe signal as in the case of FIG. 2). If, on the other hand, a synchronization signal shifted through 90°, as in the case in FIGS. 1 and 3, is received in the arrangement shown in FIG. 2 rather than the strobe signal S shown there, the phase shifter 22 must be removed from the latching signal path, and must be connected upstream of the reference inputs of the phase detectors 13, instead. In all cases, it is also possible to omit the phase shifters 22 and 22′, respectively, and to integrate their function in the individual controllable delay elements 12 and 12′, respectively. This may be done, for example, by shifting the control range of these elements appropriately.

The arrangement shown in FIG. 3 can also be modified such that the receiving and/or transmitting transfer channels are provided with latching reception and transmission circuits, respectively, and the controllable delay elements are used for delaying the latching signals in a controlled manner, in a similar way to that described above with reference to FIG. 2.

In addition to the D channels, transfer channels which transmit synchronized command signals can also be provided with corresponding controllable delay elements and phase detectors, in order to provide time calibration for the command signals as well, to be precise in a similar way to that described above for the data signals.

Signal sequences which appear during user operation can also, in some circumstances, be used as signal sequences on the basis of which the calibration is carried out, provided or as long as it is possible to produce a unique association between the signal transitions that appear and the time base. However, if there is a possibility that this precondition will not always be satisfied, a separate monitoring circuit (not illustrated in the figures) can be provided, to identify when the precondition is actually satisfied. The monitoring device can block the passing-on of a delay control signal, which is continuously updated and is temporarily stored at the output of a phase detector 13 or 13′, to the relevant delay device 12 or 12′, respectively, for as long as said precondition is not satisfied, and can enable this only by means of an activation command, once it has confirmed that the precondition is satisfied. The delay which has to be accepted in this case can be tolerated since the phase shifts to be compensated for take place on such a long timescale that it is sufficient to compensate for them effectively only after a large number of periods of the synchronization signal. There is thus sufficient time to reject a phase error which has been determined in the phase detector, and the relevant control signal, and not to pass this on to the delay element if no signal sequence is found which is suitable for calibration purposes, or if no signal sequence whatsoever is found.

In the case of data signals, the errors τ_{A} and τ_{B} which are shown in FIG. 1 must not exceed one quarter of the period of the synchronization signal or half a bit period. The monitoring device mentioned above can thus preferably be designed such that it blocks the passing-on of the delay control signal unless two signal transitions in the data signal have been identified within a time window which is greater than one bit period and is less than two bit periods.

I claim:

1. A configuration for calibrating an interface, with a plurality of parallel transfer channels for transmission of a number of parallel data signals and, optionally, command signals between associated outer connections and associated circuit nodes in an electronic assembly, and with at least one synchronization signal connection for a synchronization signal determining a time base for the parallel-transmitted signals, comprising:
individually controllable delay devices respectively contained in selected transfer channels for setting a time delay for the signal transmission in the respective transfer channel as a function of a delay control signal;
a control device connected in the interface and including a sensing means for sensing, in each selected transfer channel, an actual value of a relative phase of the respective data signal with respect to an associated, accompanying synchronization signal, and means for producing the delay control signal in dependence on a respectively sensed actual value for controlling each of said delay devices in order to match the actual value to a predetermined, common setpoint value.

2. The configuration according to claim 1, wherein each said controllable delay device is formed by a variable delay element, inserted into a signal path carrying the signal to be transmitted, of the respective transfer channel.

3. The configuration according to claim 1, which comprises a latch circuit connected to pass the signal to be transmitted through a respective transfer channel, and wherein each said controllable delay device is formed by a variable delay element in a latch signal line connected to said latch circuit.

4. The configuration according to claim 1, which comprises a separate phase detector contained in each selected transfer channel, said phase detectors each having a signal input connected for receiving the signal delayed by a respectively associated said controllable delay device, a reference input connected for receiving the associated synchronization signal, and an output the connected to a delay control input of the respective said delay device and carrying a sense signal indicating a magnitude and a direction of a time shift between flanks of the input signals present at said two inputs.

5. The configuration according to claim 1, wherein the selected transfer channels are transfer channels transmitting received signals from the outer connections to the assembly.

6. The configuration according to claim 5, wherein the selected transfer channels also include transfer channels for transmitting signals from the assembly to the outer connections.

7. The configuration according to claim 1, wherein said control device further comprises:
a memory device for temporarily storing the delay control signals being produced;
a monitoring device for monitoring the signals to be transmitted via the selected transfer channels and for producing an activation command when the signals contain transitions that can be uniquely associated with the time base; and
a switching device for applying a temporarily stored delay control signal to the relevant delay device only when said monitoring device produces an activation command.

8. The configuration according to claim 7, wherein said monitoring device is configured to produce the activation command for the binary data signals to be transmitted, when two binary transitions occur in the signals within a time window greater than one bit period and smaller than two bit periods.

9. A method of calibrating an interface having a plurality of parallel transfer channels, the method which comprises:
temporarily switching on the control device according to claim 1, prior to a start of user operation of the interface or in pauses during user operation; and
causing a source supplying the signals to be transmitted via the selected transfer channels, while the control device is in the switched-on state, to produce the signals in each case as a pattern signal with signal transitions that can be uniquely associated with the time base.

10. The method according to claim 9, which comprises producing a periodic binary sequence as the pattern signal.

11. The method according to claim 10, wherein the periodic binary sequence is a binary sequence alternating bit-by-bit.

12. The method according to claim 9, which comprises producing a pseudo-random sequence of binary values as the pattern signal.

13. A method of calibrating an interface, which comprises providing a configuration according to claim 1, and at least temporarily activating the control device during user operation of the interface.

14. The method according to claim 13, which comprises keeping the control device activated for examples of the selected transfer channels during user operation of the interface, but applying any delay control signals produced in that case to the relevant delay device only when transitions occur in the signal to be transmitted via the relevant transfer channel that can be uniquely associated with the time base.

15. A method of calibrating an interface, which comprises providing a configuration according to claim 7, and maintaining the configuration in operation during a user operation of the interface.
